(19) United States
(12) Patent Application Publication
(10) Pub. No.: US 2011/0240528 A1
(43) Pub. Date: Oct. 6, 2011

(54) Metal Recycling Separator and Method of Use Thereof

(76) Inventor: Ariel Ruiz, Forest Park, GA (US)

(21) Appl. No.: 12/749,853

(22) Filed: Mar. 30, 2010

(51) Int. Cl. B03C 1/30; B02C 23/00

(52) U.S. Cl. 209/38; 209/219; 209/214; 241/101.2

(57) ABSTRACT

A metal recycling separator comprising a shredder having a sloped shaking table disposed entirely within the shredder. The shredder shreds materials into ferrous and non-ferrous materials and the sloped shaking table disperses the ferrous and non-ferrous materials onto a first conveyor belt. Non-ferrous materials are separated from ferrous materials by conveying such through two drum electromagnets, wherein the ferrous material and the remaining non-ferrous materials are transferred to a water receptacle. The water receptacle is filled with water, wherein a part of the remaining non-ferrous materials float out of the water receptacle, and the remaining ferrous materials sink to the bottom of the water receptacle. The ferrous materials and residual non-ferrous materials are then conveyed out of the water receptacle and onto two conveyor belts and a third drum electromagnet. Ferrous material is removed from the two conveyor belts and is also removed via the third drum electromagnet.

### CROSS-REFERENCE TO RELATED APPLICATIONS

### None

### FEDERALLY SPONSORED RESEARCH OR DEVELOPMENT

### None

### PARTIES TO A JOINT RESEARCH AGREEMENT

### None

### REFERENCE TO A SEQUENCE LISTING

### None

### BACKGROUND OF THE INVENTION

1. Technical Field of the Invention

The preferred embodiment relates generally to a metal recycling separator and method of use thereof, and more specifically to separating ferrous and non-ferrous materials utilizing a shredder with a sloped shaking table disposed entirely within the shredder, a plurality of conveyor belts, a plurality of drum electromagnets and a water tank.

2. Description of Related Art

Garbage in landfills contain both ferrous and non-ferrous materials. Ferrous materials contain iron and are resistance to corrosion. Non-ferrous metal do not contain iron. Generally, it is beneficial to separate and recover ferrous materials from non-ferrous materials from a landfill site because ferrous materials may be re-utilized for building, manufacturing, tool making and other industrial supplies.

Currently, there are various types of recycling devices and/or systems for shredding and sorting materials. One device teaches a dynamic landfill recycling system, wherein separate vehicular units are combined to form a continuous solid waste processing platform, and wherein the individual vehicular units may continue to work even when not combined. While such a device shreds and sorts materials, it does not comprise a water tank to efficiently separate heavy ferrous materials from lighter non-ferrous materials.

Another device discloses a process for reclaiming wood debris, wherein one of the individual components within the system is a sink/float water tank. During the separation process, debris fragments are conveyed to a tank that is filled with water. The water tank has two exiting conveyors extending outwardly from the water tank. One conveyor is positioned near the surface of the water and the other conveyor is positioned near the bottom of the water. As the debris falls into the water tank, the heavier fragments of wood debris fall to the lower conveyor to be conveyed out of the water tank, while the lighter fragments of wood debris continually float on the surface water until contacting the surface conveyor, and then are subsequently conveyed out. While such a device utilizes a sink/float water tank, the sink/float water tank requires more than one conveyor belt extending outwardly from the water tank in order to separate debris.

Yet another device discloses a fire safety device for an outlet of a shredder device. The shredder receives and shreds metal and paper fragments, and the shredded metal and paper fragments fall to the bottom of an outlet. The safety device is incorporated into the shredder to prevent oxygen from entering the exhaust chute so that a fire cannot be sustained in the shredder. The safety device comprises a hydraulic ram, which periodically moves the shredded materials from the outlet onto a vibrating table. While such a device shreds materials, the shredded materials are not separated and dispersed evenly before the hydraulic ram pushes them onto a vibrating table.

Still yet another device teaches a method for separating ferromagnetic materials comprising an electromagnetic separator. The electromagnetic separator utilizes a conveyor belt and a cylindrical drum that is rotated around its axis by means of a motor and a chain drive. Inside the drum are solenoids connected to a current supply, which generate a magnetic field. Debris that has ferrous material intermixed is conveyed to the electromagnetic drum. Materials not attracted to the magnetic field generated by the drum stay in contact with the conveyor until dropping off into a first collection bin. Ferrous materials attracted to the magnetic field move from the conveyor belt to the surface of the drum. Once connected to the drum, the ferrous materials will stay connected as the drum rotates around its axis. The drum will eventually rotate past a small non-magnetic sensor, and, as it does, the ferrous material will become un-attracted to the drum and instantly fall off into a second collection bin. While such a device allows for reclaiming of wood from debris, it does not shred materials that directly fall onto a shaking table, thereby allowing the shredded to disperse before them are moved onto a conveyor belt.

While all of the aforementioned devices are associated with separating and/or shredding materials, none of the aforementioned devices teach a shredder comprising a vibrating table disposed entirely within, thereby allowing the slowing decent of potentially damaging shredded objects onto a conveyor belt, while simultaneously dispensing the various sized objects more evenly onto the conveyor belt.

Therefore, it is readily apparent that there is a need for an apparatus that incorporates a vibrating table entirely within a shredder, such that shredded materials disperse evenly before they are transported to other separating mechanisms.

### BRIEF SUMMARY OF THE INVENTION

Briefly described, in a preferred embodiment, the present invention overcomes the above-mentioned disadvantages and meets the recognized need for such an apparatus by providing a metal recycling separator comprising a shredder with a sloped shaking table disposed entirely within the shredder. The shaking table disperses shredded ferrous materials and non-ferrous materials onto a first separating section comprising a first conveyor belt, a first drum electromagnet, a flat shaking table, a second drum electromagnet, a second conveyor belt and a third drum electromagnet. The first separating section separates shredded ferrous materials from a first, second and third portion of shredded non-ferrous materials. The shredded ferrous materials, along with a remaining fourth portion of shredded non-ferrous materials are subsequently transferred to a second separating section comprising a bin having shakers, a second panel, a water receptacle, a fourth conveyor belt, a fifth conveyor belt, a third drum electromagnet, a sixth conveyor belt and a seventh conveyor belt. The water receptacle is selectively filled with water, wherein a fifth portion of shredded ferrous materials floats out of the water receptacle, thereby leaving the shredded ferrous materials and a sixth portion of shredded non-ferrous materials in the bottom of the water receptacle. The shredded ferrous materials and the sixth portion of shredded non-ferrous materials in the bottom of the water receptacle are then conveyed out of the receptacle tank via a fourth conveyor belt. A first portion of shredded ferrous materials are manually removed from fifth conveyor belt, a second portion of shredded ferrous materials are removed via the third drum electromagnet and a third and fourth portion of shredded ferrous materials are removed from the sixth conveyor belt.

According to its major aspects and broadly stated, the preferred embodiment is a metal recycling separator comprising a first separating section and a second separating section. The first separating section comprises a shredder having a shredding portion and a sloped shaking table. The sloped shaking table is disposed entirely within the shredder and below the shredding mechanism of the shredder. The sloped shaking table comprises a first end and a second end and is disposed at a downward angle from the first end to the second end. The first end of the sloped shaking table receives shredded materials from the shredding mechanism. The shredded materials comprise shredded non-ferrous materials and shredded ferrous materials. The shaking of the sloped shaking table causes the shredded ferrous and the shredded non-ferrous materials to disperse from the first end of the sloped shaking table to the second end of the sloped shaking table and onto a first conveyor belt.

The first conveyor belt conveys the shredded non-ferrous materials and the shredded ferrous materials to a first sloped chute and a first drum electromagnet. A first portion of the shredded non-ferrous materials slides down the first sloped chute to a first shredded non-ferrous collection section. Concurrently, the shredded ferrous materials are magnetically attracted by the first drum electromagnet. The first drum electromagnet circularly rotates and is alternatively first energized to attract and retain the shredded ferrous materials and is subsequently de-energized to deposit the shredded ferrous materials onto a first end of a flat shaking table. A second portion of the shredded non-ferrous materials, carried along with the shredded ferrous materials attracted to the first drum electromagnet, is also deposited onto the first end of the flat shaking table.

The flat shaking further comprises a second end having a second sloped chute and a second drum electromagnet. The shaking of the flat shaking table disperses the second portion of the shredded non-ferrous materials and the shredded ferrous materials to the second sloped chute and the second drum electromagnet. The second portion of the shredded non-ferrous materials slides down the second sloped chute to a second shredded non-ferrous collection section. Concurrently, the shredded ferrous materials on the flat shaking table are magnetically attracted to the second drum electromagnet. The second drum electromagnet circularly rotates and is alternately first energized to attract and retain the shredded ferrous materials and is subsequently de-energized to deposit the shredded ferrous materials onto a first end of a second conveyor belt. A third portion of the non-ferrous materials, carried along with the shredded ferrous material attracted to the second drum electromagnet, is also deposited onto the first end of the second conveyor belt along with the shredded ferrous materials.

Subsequently, the third portion of the shredded non-ferrous materials and the shredded ferrous materials are conveyed to a second end of the second conveyor belt. The third portion of the shredded non-ferrous materials are manually removed from a second end of the second conveyer belt and deposited down a third sloped chute to a third shredded non-ferrous collection section, thereby leaving a fourth portion of shredded non-ferrous materials remaining on the second conveyor belt. The second end of the second conveyor belt is disposed proximate a third conveyor belt. The third conveyor belt comprises a first end and a second end. The fourth portion of the shredded non-ferrous materials and the shredded ferrous materials on the second end of the second conveyor belt are further conveyed to the third conveyor belt. The third conveyor belt carries the fourth portion of the shredded non-ferrous materials and the shredded ferrous materials to a first collection depository.

The fourth portion of the shredded non-ferrous materials and the shredded ferrous materials in the first collection depository are transported via a machine to a second separating section comprising a bin. The bin comprises bin shakers and is disposed proximate a sloped panel. The sloped panel is disposed proximate a water receptacle comprising a top and a bottom. The sloped panel comprises a first end and a second end and is disposed at a downward angle from the first end toward the second end. The first end of the second sloped shaking table receives the fourth portion of the shredded non-ferrous materials and the shredded ferrous materials from the bin, and subsequently drops the fourth portion of the shredded non-ferrous materials and the shredded ferrous materials into the top of the water receptacle.

The water receptacle comprises a sloped sieve wall disposed on a side of the water tank. A fourth conveyor belt is disposed proximate the bottom section of the water receptacle. As the water receptacle is selectively filled with water, a fraction of the water and a fifth portion of the shredded non-ferrous materials float together out of the water tank and down the sloped sieve wall to a fourth shredded non-ferrous collection section, and the fraction of the water is drained through the sloped sieve wall. Concurrently, as the shredded ferrous material is denser than water, the shredded ferrous material, along with a remaining sixth portion of the shredded non-ferrous materials, sink into the bottom of the water receptacle.

Subsequently, the sixth portion of the shredded non-ferrous materials and the shredded ferrous materials in the water receptacle are conveyed out of the water receptacle via the fourth conveyor belt. The fourth conveyor belt comprises a first end and a second end, and the second end of the fourth conveyor belt is disposed proximate a fifth conveyor belt. The sixth portion of the shredded non-ferrous materials and the ferrous shredded materials are further conveyed from the second end of the fourth conveyor belt and drop onto the first end of said fifth conveyor belt via a first drop table. The first end of the fifth conveyor belt comprises a pair of fourth sloped chutes. The fifth conveyor belt further comprises a second end having a third drum electromagnet and a pair of fifth sloped chutes. A first portion of the shredded ferrous materials are manually removed from the first end of the fifth conveyor belt and dropped down the pair of fourth sloped chutes to a first shredded ferrous materials collection section. A second portion of the shredded ferrous materials and the sixth portion of the shredded non-ferrous materials are further conveyed together to the third drum electromagnet. As the third drum electromagnet circularly rotates, it alternately attracts the second portion of the shredded ferrous materials and releases the second portion of the shredded ferrous materials down the pair of fifth sloped chutes to a second shredded ferrous materials collection.

Consequently, a remaining third portion of the shredded ferrous materials (not picked by the third drum electromagnet) and the sixth portion of the shredded non-ferrous materials are conveyed from the second end of the fifth conveyor belt and onto a sixth conveyor belt. The sixth conveyor belt further comprises a pair of sixth sloped chutes and a pair of seventh sloped chutes. A third portion of the shredded ferrous materials are manually removed from the sixth conveyor belt and dropped down the pair of sixth sloped chutes to a third shredded ferrous materials collection section. Additionally, a remaining fourth portion of shredded ferrous materials are manually collected from the sixth conveyor belt and dropped down the pair of seventh sloped chutes to a fourth shredded ferrous materials collection section.

The sixth conveyor belt further comprises a second end disposed proximate a seventh conveyor belt. The sixth portion of the shredded non-ferrous materials is conveyed to the second end of the sixth conveyor belt and drops onto a first end of the seventh conveyor belt via second drop table. The sixth portion of the shredded non-ferrous materials is further conveyed to a second end of seventh conveyor belt and falls into a final garbage section. Accordingly, the first, second, third and fourth shredded ferrous material collection sections comprise the ferrous materials separated from the first, second, third and fourth shredded non-ferrous collection section, wherein the shredded ferrous materials in the first, second, third and fourth shredded ferrous material collection sections are selectively utilized for other purposes, such as, for exemplary purposes, manufacturing needs.

In one embodiment, the shredder, the first conveyor belt, the first drum electromagnet, the flat shaking table, the second electromagnet, the second conveyor belt, the third conveyor belt, the bin, the water tank, the fourth conveyor belt, the third drum electromagnet, the fifth conveyor belt, the sixth conveyor belt and the seventh conveyor belt may selectively be grouped together into modular sections that can be deconstructed for transportation purposes, and then reconstructed and aligned in varying orders.

Additionally, the preferred embodiment is a method of separating recyclable materials comprising the step of obtaining a first separating section comprising a shredder, a first conveyor belt, a first sloped chute, a first drum electromagnet, a flat shaking table, a second sloped chute, a second electromagnet, a second conveyor belt, a third sloped chute and a third conveyor belt. The method further comprises the step of placing materials into the shredder, such that the materials are shredded into shredded non-ferrous and shredded ferrous materials, and the shaking of the sloped shaking table disperses the shredded ferrous and shredded non-ferrous materials onto the first conveyor belt. The method further comprises the step of conveying the shredded non-ferrous and the shredded ferrous materials to a first sloped chute and a first drum electromagnet. A first portion of the shredded non-ferrous materials falls down the first sloped chute. Concurrently the shredded ferrous materials are magnetically attracted to the first drum electromagnet and subsequently released onto the flat shaking table. A second portion of the shredded non-ferrous materials, carried along with the ferrous materials attached to the first drum electromagnet, also falls onto the flat shaking table.

The method further comprises the step of transferring the second portion of the shredded non-ferrous materials and the shredded ferrous materials to the second sloped chute and the second drum electromagnet via the flat shaking table. The second portion of the shredded non-ferrous materials fall down the second sloped chute into a second shredded non-ferrous collection section. The shredded ferrous materials are magnetically attracted to the second drum electromagnet and are released onto the second conveyor belt. A third portion of the shredded non-ferrous materials, carried along with the ferrous materials attracted to the second drum electromagnet, are also conveyed onto the second conveyor belt.

The method further comprises the step of removing the third portion of the shredded non-ferrous materials from the second conveyor belt and releasing the third portion of the shredded non-ferrous materials down the third sloped chute into a third shredded non-ferrous collection section. Additionally, the method comprises the step of conveying a fourth portion of the shredded non-ferrous materials and the shredded ferrous materials onto the third conveyor belt. The third conveyor belt conveys the fourth portion of the shredded non-ferrous material and the ferrous shredded materials into a first collection section.

The method further comprising the steps of obtaining a second separating section. The second separating section comprises a bin, a water receptacle, a fourth conveyor belt, a pair of fourth sloped chutes, a third drum electromagnet, a pair of fifth sloped chutes, a fifth conveyor belt, a pair of sixth and seventh sloped chutes and a seventh conveyor belt. The method further comprises the step of transporting and depositing the shredded ferrous materials and the fourth portion of the shredded non-ferrous materials from the first collection section into the bin. The method further comprises the step of dispersing the shredded ferrous materials and the fourth portion of the shredded non-ferrous materials from the bin and into the water receptacle via the first sloped panel. Subsequently, the water receptacle is filled with water and a fifth portion of the shredded non-ferrous materials floats out of the water receptacle and onto a sloped sieve wall. The method further comprises the step of conveying a sixth portion of the shredded non-ferrous materials and the shredded ferrous materials out of the bottom water receptacle via the fourth conveyor belt onto the fifth conveyor belt and manually removing a first portion of the shredded ferrous materials from the fifth conveyor belt down the pair of fourth sloped chutes and into a first shredded ferrous collection section.

The method further comprises the steps of conveying a remaining second portion of the shredded ferrous materials and the sixth portion of the shredded non-ferrous materials underneath the third drum electromagnet via the fifth conveyor belt. The third drum electromagnet attracts the second portion of the shredded ferrous materials, and subsequently releases the second portion of the shredded ferrous materials down the pair of fifth sloped chutes into a second shredded ferrous collection section.

The method further comprises the steps of conveying a remaining third portion of the shredded ferrous materials and the sixth portion of the shredded non-ferrous materials onto the sixth conveyor belt and manually removing a third and a fourth portion of the shredded ferrous materials from the sixth conveyor belt onto a pair of sixth and seventh sloped chutes, and into a third and fourth shredded ferrous collection section, respectively. Lastly, the method comprises the steps of conveying the sixth portion of the shredded non-ferrous materials onto the seventh conveyor belt to a final garbage section. Accordingly, the first, second, third and fourth shredded ferrous collection sections comprise ferrous materials separated from the non-ferrous materials that may be utilized for other purposes, such as construction.

Additionally, the preferred embodiment is a shredder comprising a shredding mechanism and a shaking table. The shaking table is disposed underneath the shredding mechanism. The shredding mechanism shreds and drops shredded materials onto the shaking table, and the shaking table disperses the shredded materials.

More specifically, the present invention is a metal recycling separator comprising a first separating section. The first separating section comprises a shredder, a first conveyor belt, a first drum electromagnet, a first sloped chute, a flat shaking table, a second drum electromagnet, a second sloped chute, a second conveyor belt, a third sloped chute, a third conveyor belt and a first collection section. The first conveyor belt comprises a first end and a second end. The flat shaking table comprises a first edge and a second edge. The second conveyor belt comprises a first end and a second end. The third conveyor belt comprises a first end and a second end.

In a preferred embodiment, the shredder is disposed proximate the first conveyor belt. The first conveyor belt is disposed proximate the first sloped chute. The first sloped chute is disposed proximate the first drum electromagnet. The first drum electromagnet is disposed proximate the flat shaking table. The flat shaking table is disposed proximate the second sloped chute. The second sloped chute is disposed proximate the second drum electromagnet. The second drum electromagnet is disposed proximate the second conveyor belt. The second conveyor belt is disposed proximate the third sloped chute. The third sloped chute is disposed proximate the third conveyor belt. It will be recognized by those skilled in the art that the first separating section comprising the shredder, the first conveyor belt, the first drum electromagnet, the first sloped chute, the flat shaking table, the second drum electromagnet, the second sloped chute, the second conveyor belt, the third sloped chute and the third conveyor belt are modular units that and can be reconstructed and deconstructed into varying orders and/or layouts.

Additionally, the shredder comprises a top, a shredding mechanism, a sloped shaking table and tracks. The top of the shredder comprises an entrance and the shredding mechanism is disposed below the entrance. The sloped shaking table is disposed below the shredding mechanism and comprises an upper end and a lower end. The sloped shaking table slopes downward from the upper end to the lower end. The lower end of the sloped shaking table is disposed proximate the first end of the first conveyor belt. Additionally, the tracks allow the shredder to be maneuverable.

In use, a construction vehicle gathers materials and dumps the materials into the entrance of the shredder. The materials pass through the shredding mechanism and become shredded materials comprising shredded non-ferrous materials and shredded ferrous materials. The shredded non-ferrous materials and the shredded ferrous materials fall onto the sloped shaking table. The downward angle of the sloped shaking table and the vibrations generated by the sloped shaking table cause the shredded non-ferrous materials and the shredded ferrous materials to disperse from the upper end to the lower end of the sloped shaking table and move onto the first end of the first conveyor belt.

Subsequently, the shredded non-ferrous materials and the shredded ferrous materials are conveyed from the first end to the second end of the first conveyor belt. A first portion of shredded non-ferrous materials is conveyed to the first sloped chute, which directs the first portion of shredded non-ferrous materials to a first shredded non-ferrous collection section. Concurrently, the magnetic field generated by the first drum electromagnet attracts the shredded ferrous materials onto the first drum electromagnet. The shredded ferrous materials attach to the first drum electromagnet as the first drum electromagnet rotates about its horizontal axis. The shredder ferrous materials remain attached to the first drum electromagnet until the first drum electromagnet reaches a first non-magnetized point. The first non-magnetized point is an area where the magnetic field generated by the first drum electromagnet is not strong enough to attract the shredded ferrous materials, thereby causing the shredded ferrous materials to detach from the first drum electromagnet and release onto the first edge of the flat shaking table. A second portion of shredded non-ferrous are carried along with the shredded ferrous materials on the first drum electromagnet and are also released onto the first edge of the flat shaking table.

Consequently, vibrations generated by the flat shaking table causes the shredded ferrous materials and the second portion of shredded non-ferrous materials to move from the first edge of the flat shaking table to the second edge of the flat shaking table. The second edge of the flat shaking table further comprises a second sloped chute. The second sloped chute directs the second portion of shredded non-ferrous materials to a second shredded non-ferrous collection section. Concurrently, the magnetic field generated by the second drum electromagnet attracts the shredded ferrous materials onto the second drum electromagnet. The shredded ferrous materials attach to the second drum electromagnet as the second drum electromagnet rotates about its horizontal axis. The shredded ferrous materials remains attached to the second drum electromagnet until the second drum electromagnet reaches a second non-magnetized point. The second non-magnetized point is an area where the magnetic field generated by the second drum electromagnet is not strong enough to attract the shredded ferrous materials, thereby causing the shredded ferrous materials to detach from the second drum electromagnet and release onto the first end of the second conveyor belt. A third portion of shredded non-ferrous material are carried along with the shredded ferrous materials on the second drum electromagnet and are also released onto the first end of the second conveyor belt.

Subsequently, a worker scans the second conveyor belt and manually removes the third portion of shredded non-ferrous materials and releases the third portion of shredded non-ferrous materials down the third sloped chute. The third sloped chute directs the third portion of shredded non-ferrous materials to a third shredded non-ferrous collection section. Accordingly, the first, second and third shredded non-ferrous collection sections comprise the first, second and third portion of shredded non-ferrous materials.

Consequently, the shredded ferrous materials and a remaining fourth portion of non-ferrous materials not manually removed by the worker are conveyed to the second end of the second conveyor belt and onto the first end of the third conveyor belt. The shredded ferrous materials and the fourth portion of the shredded non-ferrous materials are further conveyed to the second end of the third conveyor belt and fall off of the second end of the third conveyor belt into a first collection section.

The shredded ferrous materials and the fourth portion of shredded non-ferrous materials are transported to a second separating section. The second separating section comprises a bin, a water tank section, a fourth conveyor belt, a fifth conveyor belt, a fourth pair of sloped chutes, a third drum electromagnet, a fifth pair of sloped chutes, a sixth conveyor belt, a sixth pair of sloped chutes, a seventh pair of sloped chutes, a seventh conveyor belt and a final collection section. The fourth conveyor belt comprises a first end and a second end. The fifth conveyor belt comprises a first edge and a second edge. The sixth conveyor belt comprises a first end and a second end. The seventh conveyor belt comprises a first end and a second end.

In a preferred embodiment, the bin is disposed proximate the water tank section. The water tank section is disposed proximate the fourth conveyor belt. The fourth conveyor belt is disposed proximate the fourth pair of sloped chutes, wherein the fourth pair of sloped chutes are disposed on each side of the fourth conveyor belt. The fourth pair of sloped chutes are disposed proximate the third drum electromagnet and the fifth pair of sloped chutes. The third drum electromagnet and the fifth pair of sloped chutes are disposed proximate the fifth conveyor belt. The fifth conveyor belt is disposed proximate the sixth conveyor belt comprising the sixth pair of sloped chutes and the seventh pair of sloped chutes. The sixth pair of sloped chutes and the seventh pair of sloped chutes are disposed on each side of the sixth conveyor belt. Lastly, the sixth conveyor belt is disposed proximate the seventh conveyor belt. It will be recognized by those skilled in the art that the second separating section comprising the bin, the water tank section, the fourth conveyor belt, the fifth conveyor belt, the fourth pair of sloped chutes, the third drum electromagnet, the fifth pair of sloped chutes, the sixth conveyor belt, the sixth pair of sloped chutes, the seventh pair of sloped chutes and the seventh conveyor belt are modular units that can be deconstructed for easy transportation, and then reconstructed in varying orders and/or layouts.

Additionally, the bin comprises bin shakers. The bin is disposed proximate a sloped panel comprising an upper end and a lower end. The sloped panel slopes downward from the upper end to the lower end. The lower end of the second sloped shaking table is disposed proximate a water tank section. The water tank section comprises a water receptacle, a water collection container and a sprinkler set. The water receptacle comprises a top, a bottom and a side. The side of the water receptacle comprises a sloped sieve wall disposed thereon. The water collection container is disposed below the water receptacle and the sloped sieve wall. The water receptacle selectively fills with water via the sprinkler set. The sprinkler set obtains water from the water tank and the water collection container via the water pipe.

In use, a construction vehicle collects and releases the shredded ferrous materials and the fourth portion of shredded non-ferrous materials from the first collection section into the bin. The shredded ferrous materials and the fourth portion of shredded non-ferrous materials fall onto the upper end of the sloped panel. The downward angle and the vibrations generated by the bin shakers cause the shredded ferrous materials and the fourth portion of shredded non-ferrous materials to move from the upper end to the lower end of the sloped shaking table and disperse into the water receptacle. The water receptacle is selectively filled with water from the water collection container and the water tank via the sprinkler set. As the water receptacle fills with water, a fifth portion of shredded non-ferrous materials float to the top of the water receptacle and onto the sloped sieve wall and into a fourth shredded non-ferrous collection section. Also, excess water flows out of the water receptacle and drips through the sloped sieve wall and into the water collection container. Concurrently, the shredded ferrous materials, carried along with a remaining sixth portion of shredded non-ferrous materials, sink to the bottom of the water receptacle. The shredded ferrous materials and the sixth portion of shredded non-ferrous materials are subsequently conveyed out of the water receptacle via the fourth conveyor belt.

The fourth conveyor belt conveys the shredded ferrous materials and the sixth portion of shredded non-ferrous materials from the first end to the second end of the fourth conveyor belt. The shredded ferrous materials and the sixth portion of the shredded non-ferrous materials drop onto the first edge of the fifth conveyor belt via a first drop table. Workers scan the fifth conveyor belt and manually remove a first portion of the shredded ferrous materials and place the first portion of the shredded ferrous materials down the fourth pair of sloped chutes. The fourth pair of sloped chutes directs the first portion of the shredded ferrous materials to a first shredded ferrous collection section. The remaining shredded ferrous materials on the fifth conveyor belt form a second portion of the shredded ferrous materials are carried along with the sixth portion of the shredded non-ferrous materials. The second portion of the shredded ferrous materials are carried along with the sixth portion of the shredded non-ferrous materials is conveyed to the second edge of the fifth conveyor belt and underneath the third drum electromagnet. The magnetic field generated by third drum electromagnet attracts the second portion of the shredded ferrous materials. The second portion of the shredded ferrous materials attach to the third drum electromagnet as the third drum electromagnet rotates about its longitudinal axis. The second portion of the shredded ferrous materials remains attached to the third drum electromagnet until the third drum electromagnet reaches third non-magnitized points. The third non-magnitized points are areas where the magnetic field generated by the third drum electromagnet is not strong enough to attract the second portion of the shredded ferrous materials, thereby causing the second portion of ferrous materials to detach from the third drum electromagnet and release onto the fifth pair of sloped chutes. The fifth pair of sloped chutes directs the second portion of ferrous materials into a second ferrous collection section.

The remaining shredded ferrous materials left on the fifth conveyor belt, after bypassing the third drum electromagnet, form a remaining third portion of the shredded ferrous materials, which are carried along with the sixth portion of the shredded non-ferrous materials. The third portion of the shredded ferrous materials and the sixth portion of the shredded non-ferrous materials are conveyed from the second edge of the fifth conveyor belt to the first edge of the sixth conveyor belt. Workers manually remove the third portion of the shredded ferrous materials and place the third portion of the shredded ferrous materials down the sixth pair of sloped chutes. Workers subsequently remove a remaining fourth portion of the shredded ferrous materials and place the fourth portion of the shredded ferrous material down the seventh pair of sloped chutes. The sixth pair of sloped chutes and the seventh pair of sloped chutes direct the third and fourth portion of ferrous materials into a third ferrous collection section and a fourth shredded ferrous collection section, respectively. The remaining sixth portion of non-the shredded ferrous materials is conveyed to the second edge of the sixth conveyor belt and onto the first end of the seventh conveyor belt. The sixth portion of non-the shredded ferrous materials are further conveyed towards the second end of the seventh conveyor belt and into the final collection section. Thus, shredded ferrous material is separated from shredded non-ferrous material and deposited in the first, second, third and fourth shredded ferrous collection sections for further use.

Accordingly, a feature and advantage of the present invention is its ability to separate shredded ferrous and shredded non-ferrous materials.

Still another feature and advantage of the present invention is it comprises modular units that can easily deconstructed for mobility from one location to another.

Yet another feature and advantage of the present invention is its ability to incorporate a sloped shaking table within a shredder, thereby efficiently dispersing shredded materials as they vibrate down the table.

Yet still another feature and advantage of the present invention is its ability to incorporate a plurality of conveyor belts, thereby allowing a worker to manually separate ferrous and non-ferrous materials.

A further feature and advantage of the present invention is its ability to conserve water by re-utilizing water collected in the water collection container.

Still another feature and advantage of the present invention is its ability to re-use the water that fills the water receptacle via a collection bin, thereby preventing wasteful usage of water.

Another feature and advantage of the present invention is that a shredder, a plurality of conveyor belts, a plurality of drum electromagnets and a water receptacle may selectively be grouped together into modular sections, which can be reconstructed in varying orders and/or layouts.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a side view of a first separating section according to a preferred embodiment, shown in use;

FIG. 2 is a side view of a shredder comprising a sloped shaking table and a shredding mechanism disposed within according to a preferred embodiment, shown with the sloped shaking table exploded out;

FIG. 3 is a side view of a second separating section according to a preferred embodiment, shown in use;

FIG. 4 is a front perspective view of the front components of the second separating section according to a preferred embodiment, shown in use; and

FIG. 5 is a side perspective view of the back components of the second separating section according to a preferred embodiment, shown in use.

### DETAILED DESCRIPTION OF THE PREFERRED AND SELECTED ALTERNATE EMBODIMENTS OF THE INVENTION

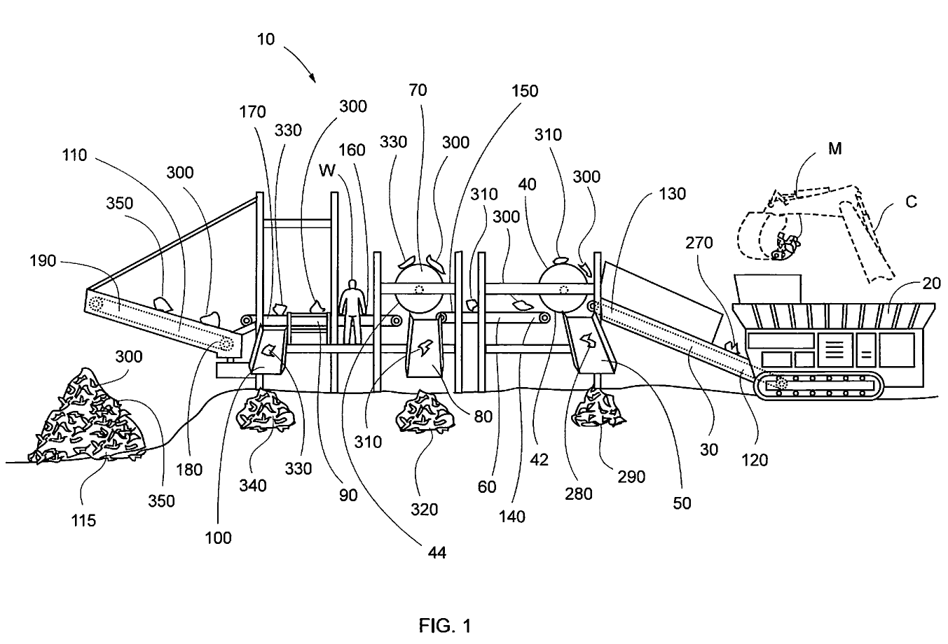

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

Referring to FIG. 1, first separating section 10 comprises shredder 20, first conveyor belt 30, first drum electromagnet 40, first sloped chute 50, flat shaking table 60, second drum electromagnet 70, second sloped chute 80, second conveyor belt 90, third sloped chute 100, third conveyor belt 110 and first collection section 115. First conveyor belt 30 comprises first end 120 and second end 130, wherein flat shaking table 60 comprises first edge 140 and second edge 150, and wherein second conveyor belt 90 comprises first end 160 and second end 170, and wherein third conveyor belt 110 comprises first end 180 and second end 190, wherein first conveyor belt 30 comprises first end 120 and second end 130, and wherein flat shaking table 60 comprises first edge 140 and second edge 150, and wherein second conveyor belt 90 comprises first end 160 and second end 170, and wherein third conveyor belt 110 comprises first end 180 and second end 190.

In one embodiment, shredder 20 is disposed proximate first end 120 of first conveyor belt 30, wherein second end 130 of first conveyor belt 30 is disposed proximate first sloped chute 50, and wherein first sloped chute 50 is disposed proximate first drum electromagnet 40, and wherein first drum electromagnet 40 is disposed proximate first edge 140 of flat shaking table 60, and wherein second edge 150 of flat shaking table 60 is disposed proximate second sloped chute 80, and wherein second sloped chute 80 is disposed proximate second drum electromagnet 70, and wherein second drum electromagnet 70 is disposed proximate first end 160 of second conveyor belt 90, and wherein second end 170 of second conveyor belt 90 is disposed proximate third sloped chute 100, and wherein third sloped chute 100 is disposed proximate first end 180 of third conveyor belt 110, and wherein second end 190 of third conveyor belt 110 conveys materials to first collection section 115.

It will be recognized by those skilled in the art that shredder 20, first conveyor belt 30, first drum electromagnet 40, first sloped chute 50, flat shaking table 60, second drum electromagnet 70, second sloped chute 80, second conveyor belt 90, third sloped chute 100, third conveyor belt 110 are modular units that may be grouped together in varying orders and/or into various aligned positions and/or deconstructed for transportation purposes.

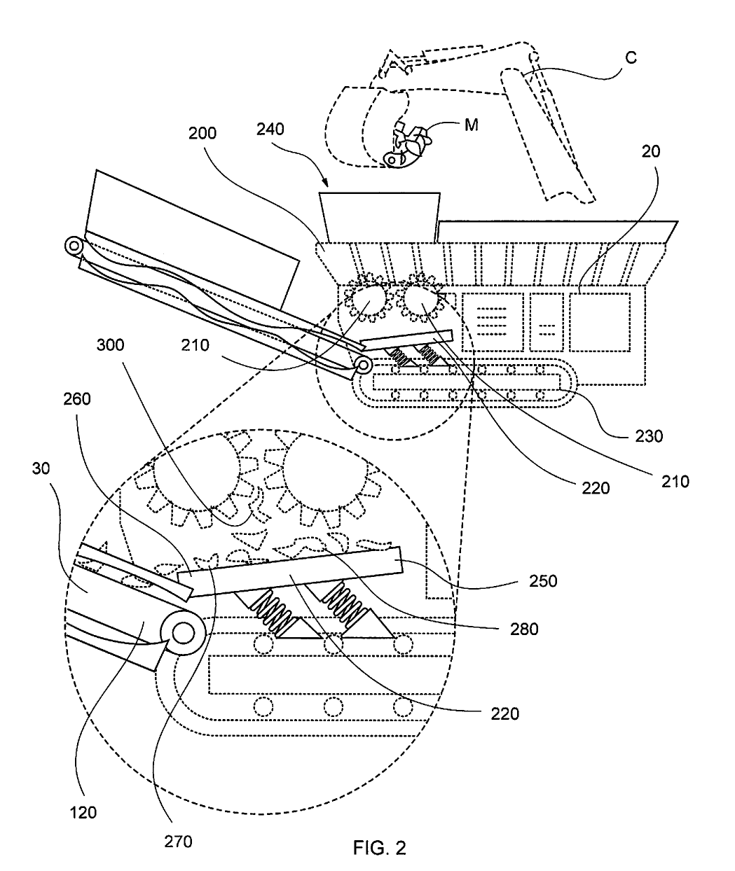

Referring now to FIG. 2, shredder 20 comprises top 200, shredding mechanisms 210, sloped shaking table 220 and tracks 230, wherein top 200 comprises entrance opening 240, and wherein shredding mechanisms 210 are disposed proximately below entrance opening 240, and wherein sloped shaking table 220 is disposed proximately below shredding mechanisms 210. Sloped shaking table 220 comprises upper end 250 and lower end 260, wherein sloped shaking table 220 slopes downward from upper end 250 to lower end 260, and wherein lower end 260 of sloped shaking table 220 is disposed proximate first end 120 of first conveyor belt 30, and wherein tracks 230 allow shredder 20 to be maneuverable.

Referring now to FIGS. 1-2, in use, construction vehicle C gathers materials M, wherein construction vehicle C dumps materials M into entrance opening 240 of shredder 20, and wherein materials M pass through shredding mechanisms 210 and become shredded materials 270, and wherein shredded materials 270 comprise shredded first portion of non-ferrous materials 280 and shredded ferrous materials 300. First portion of shredded non-ferrous materials 280 and shredded ferrous materials 300 fall onto sloped shaking table 220, wherein the downward angle and vibrations generated by sloped shaking table 220 cause shredded first portion of non-ferrous materials 280 and shredded ferrous materials 300 to disperse from upper end 250 to lower end 260 of sloped shaking table 220 and onto first end 120 of first conveyor belt 30. First portion of shredded non-ferrous materials 280 and shredded ferrous materials 300 are subsequently conveyed from first end 120 to second end 130 of first conveyor belt 30. As first portion of shredded non-ferrous materials 280 reach the second end 130 of first conveyor belt 30, first portion of shredded non-ferrous materials 280 subsequently descend down first sloped chute 50, wherein first sloped chute 50 directs first portion of shredded non-ferrous materials 280 to first shredded non-ferrous collection section 290. Concurrently, as shredded ferrous materials 300 reach the second end 130 of first conveyor belt 30, the magnetic field generated by first drum electromagnet 40 attracts shredded ferrous materials 300 onto first drum electromagnet 40, wherein shredded ferrous materials 300 attach to first drum electromagnet 40 as first drum electromagnet 40 rotates about its horizontal axis. Shredded ferrous materials 300 remain attached to first drum electromagnet 40 until first drum electromagnet 40 reaches first non-magnetized point 42, wherein first wherein non-magnetized point 42 is an area where the magnetic field generated by first drum electromagnet 40 is not strong enough to attract shredded ferrous materials 300, thereby causing shredded ferrous materials 300 to detach from first drum electromagnet 40 and release onto first edge 140 of flat shaking table 60. Shredded ferrous materials 300 are carried along with second portion of shredded non-ferrous materials 310, wherein second portion of shredded non-ferrous materials 310 are remaining first portion of shredded non-ferrous materials 300 that did not descend down first sloped chute 50, and wherein second portion of shredded non-ferrous materials 310 are carried along with shredded ferrous materials 300 on first drum electromagnet 40 and subsequently released onto first edge 140 of flat shaking table 60.

Still referring to FIG. 1, vibrations generated by flat shaking table 60 cause shredded ferrous materials 300 and second portion of shredded non-ferrous materials 310 to move from first edge 140 of flat shaking table 60 to second edge 150 of flat shaking table 60. As shredded ferrous materials 300 and second portion of shredded non-ferrous materials 310 move toward second edge 150 of flat shaking table 60, second portion of shredded non-ferrous materials 310 descend down second sloped chute 80, wherein second sloped chute 80 directs second portion of shredded non-ferrous materials 310 to second shredded non-ferrous collection section 320. Concurrently, the magnetic field generated by second drum electromagnet 70 attracts shredded ferrous materials 300 onto second drum electromagnet 70, wherein shredded ferrous materials 300 attach to second drum electromagnet 70 as second drum electromagnet 70 rotates about its horizontal axis. Shredded ferrous materials 300 remain attached to second drum electromagnet 70 until second drum electromagnet 70 reaches second non-magnetized point 44, wherein second non-magnetized point 44 is an area where the magnetic field generated by second drum electromagnet 70 is not strong enough to attract shredded ferrous materials 300, thereby causing shredded ferrous materials 300 to detach from second drum electromagnet 70 and release onto first end 160 of second conveyor belt 90. Shredded ferrous materials 300 are carried along with third portion of shredded non-ferrous materials 330, wherein third portion of shredded non-ferrous materials 330 are remaining second portion of shredded non-ferrous materials 310 that did not descend down first sloped chute 80, and wherein third portion of shredded non-ferrous materials 330 are carried along with shredded ferrous materials 300 on second drum electromagnet 70 and subsequently released onto first end 160 of second conveyor belt 90. Third portion of shredded non-ferrous materials 330 and shredded ferrous materials 300 are further conveyed to second end 170 of second conveyor belt 90, wherein a worker standing alongside second conveyor belt 90 manually removes third portion of shredded non-ferrous materials 330, and wherein the worker releases third portion of shredded non-ferrous materials 330 down third sloped chute 100, and wherein third sloped chute 100 directs third portion of shredded non-ferrous materials 330 to third shredded non-ferrous collection section 340.

Still referring to FIG. 1, shredded ferrous materials 300 and fourth portion of shredded non-ferrous materials 350, wherein fourth portion of shredded non-ferrous materials 350 are remaining third portion of shredded non-ferrous 330 materials not removed from second conveyor belt 90 by the worker, are further conveyed from second end 170 of second conveyor belt onto first end 180 of third conveyor belt 110. Shredded ferrous materials 300 and fourth portion of shredded non-ferrous materials 350 are further conveyed to second end 190 of third conveyor belt 110, wherein shredded ferrous materials 300 and fourth portion of shredded non-ferrous materials 350 drop off of second end 190 of third conveyor belt 110 into first collection section 115. Accordingly, first separating section 10 separates shredded ferrous materials 300 away from first portion of shredded non-ferrous materials 310, second portion of shredded non-ferrous materials 320 and third portion of shredded non-ferrous materials 330.

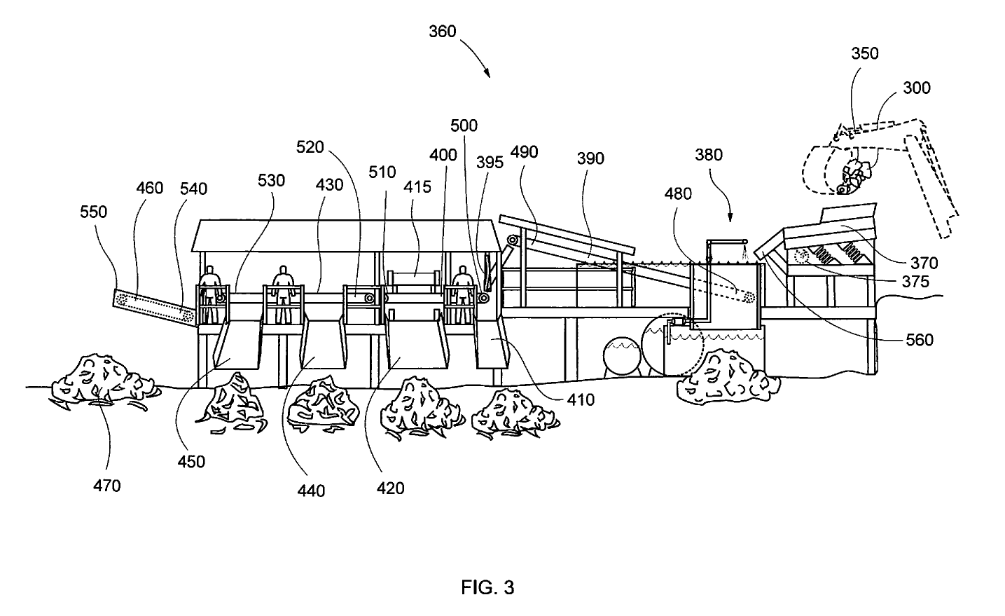

Referring now to FIG. 3, shredded ferrous materials 300 and fourth portion of shredded non-ferrous materials 350 are transported to second separating section 360. Second separating section 360 comprises bin 370, bin shakers 375, water tank section 380, fourth conveyor belt 390, first drop table 395, fifth conveyor belt 400, fourth pair of sloped chutes 410, third drum electromagnet 415, fifth pair of sloped chutes 420, sixth conveyor belt 430, sixth pair of sloped chutes 440, seventh pair of sloped chutes 450, seventh conveyor belt 460 and final collection section 470, wherein fourth conveyor belt 390 comprises first end 480 and second end 490, and wherein fifth conveyor belt 400 comprises first edge 500 and second edge 510, and wherein sixth conveyor belt 430 comprises first end 520 and second end 530, and wherein seventh conveyor belt 460 comprises first end 540 and second end 550.

In one embodiment, bin 370 is disposed proximate water tank section 380, wherein water tank section 380 is disposed proximate first end 480 of fourth conveyor belt 390, and wherein second end 490 of fourth conveyor belt 390 is disposed proximate fourth pair of sloped chutes 410, and wherein fourth pair of sloped chutes 410 are disposed proximate first edge 500 of fifth conveyor belt 400, and wherein third drum electromagnet 415 and fifth pair of sloped chutes 420 is disposed proximate second edge 510 of fifth conveyor belt 400, and wherein second edge 510 of fifth conveyor belt is disposed proximate first edge 520 of sixth conveyor belt 430, and wherein sixth pair of sloped chutes 440 are disposed proximate first edge 520 of sixth conveyor belt 430, and wherein seventh pair of sloped chutes 450 are disposed proximate second edge 530 of sixth conveyor belt 430, and wherein second edge 530 of sixth conveyor belt 430 is disposed proximate first end 540 of seventh conveyor belt 460, and wherein second end 550 of seventh conveyor belt 460 conveys materials to final collection section 470.

It will be recognized by those skilled in the art that second separating section 360 comprising bin 370, water tank section 380, fourth conveyor belt 390, fifth conveyor belt 400, fourth pair of sloped chutes 410, third drum electromagnet 415, fifth pair of sloped chutes 420, sixth conveyor belt 430, sixth pair of sloped chutes 440, seventh pair of sloped chutes 450, seventh conveyor belt 460 are modular units that may be grouped together in varying orders and/or into various aligned positions and/or are easily reconstructed and/or deconstructed for transportation purposes.

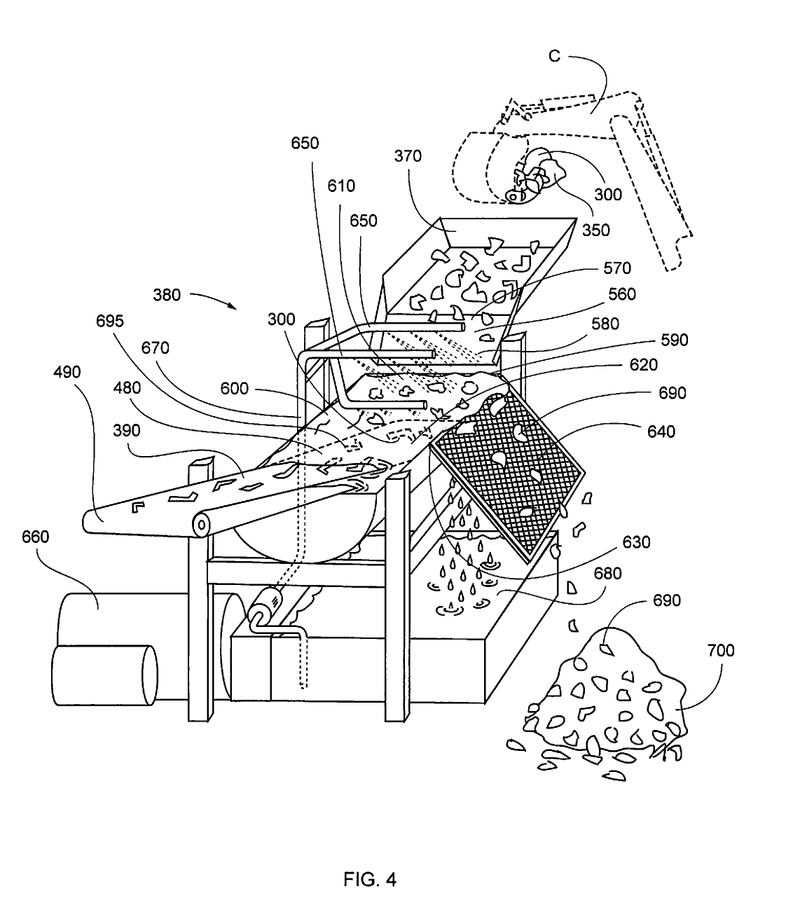

Referring now to FIG. 4, bin 370 is disposed proximate sloped panel 560, wherein sloped panel 560 comprises upper end 570 and lower end 580, and wherein sloped panel 560 slopes downward from upper end 570 to lower end 580, and wherein lower end 570 of sloped panel 560 is disposed proximate first end 590 of water tank section 380. Water tank section 380 comprises water receptacle 600, water collection bin 680 and sprinkler set 650, wherein water receptacle 600 comprises top 610, bottom 620 and side 630, and wherein side 630 comprises sloped sieve wall 640 disposed thereon, and wherein water collection bin 680 is disposed below said water receptacle 600 and sloped sieve wall 640. Water that overflows water receptacle 600 is collected in water collection bin 680, wherein sprinkler set 650 utilizes water accumulated in water collection bin 680 and water stored in water tank 660 to continuously refill water receptacle 600.

Still referring to FIG. 4, in use, construction vehicle C collects and releases shredded ferrous materials 300 and fourth portion of shredded non-ferrous materials 350 from first collection section 115 (as shown in FIG. 1) into bin 370, wherein bin shakers 375 shake shredded ferrous materials 300 and fourth portion of shredded non-ferrous materials 350 onto upper end 570 of sloped panel 560, and wherein the downward angle of sloped panel 560 cause shredded ferrous materials 300 and fourth portion of shredded non-ferrous materials 350 to move from upper end 570 to lower end 580 of sloped panel 560 and disperse into water receptacle 600. Water receptacle 600 selectively fills with water via sprinkler set 650, wherein sprinkler set 650 obtains water from water tank 660 and water collection bin 680 via water pipe 670. As water receptacle 600 completely fills with water, fifth portion of shredded non-ferrous materials 690 floats to top 610 of water receptacle 600 and onto sloped sieve wall 640. Excess water and fifth portion of shredded non-ferrous materials 690 slide down sloped sieve wall 640, wherein excess water drips through sloped sieve wall 640 into water collection bin 680, and wherein fifth portion of shredded non-ferrous materials 690 drop onto fourth shredded non-ferrous collection section 700. Concurrently, shredded ferrous materials 300, due to their density being greater than that of water, sink to bottom 620 of water receptacle 600, wherein shredded ferrous materials 300 are carried along with sixth portion of shredded non-ferrous materials 695, and wherein sixth portion of shredded non-ferrous materials 695 are remaining fourth portion of shredded non-ferrous materials 350 that did not float out of water receptacle 600. Subsequently, shredded ferrous materials 300 and sixth portion of shredded non-ferrous materials 695 are conveyed out of water receptacle 600 via fourth conveyor belt 390.

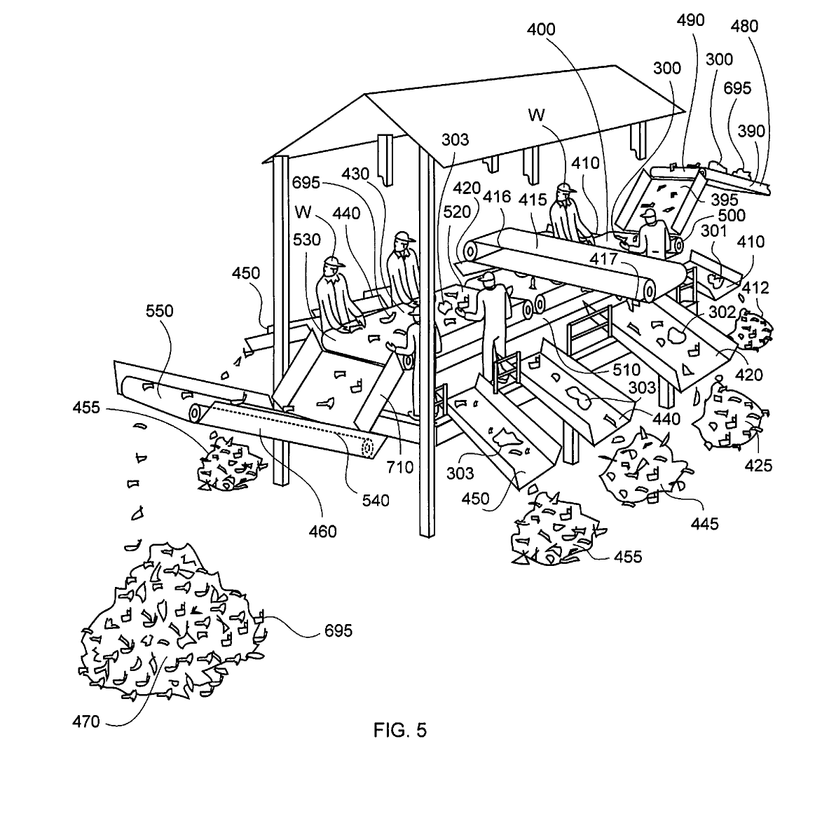

Referring now to FIG. 5, fourth conveyor belt 390 conveys shredded ferrous materials 300 and sixth portion of shredded non-ferrous materials 695 from first end 480 to second end 490 of fourth conveyor belt 390, wherein shredded ferrous materials 300 and sixth portion of shredded non-ferrous materials 695 drop onto first edge 500 of fifth conveyor belt 400 via first drop table 395. Subsequently, workers W standing along both sides fifth conveyor belt 400 manually remove first portion of shredded ferrous materials 301 and drop first portion of shredded ferrous materials 301 down fourth pair of sloped chutes 410, wherein fourth pair of sloped chutes 410 direct first portion of shredded ferrous materials 301 to first shredded ferrous collection section 412. Remaining shredded ferrous materials 300 on fifth conveyor belt 400 form second portion of shredded ferrous materials 302 carried along with sixth portion of shredded non-ferrous materials 695 are further conveyed to second edge 510 of fifth conveyor belt 400 and underneath third drum electromagnet 415, wherein the magnetic field generated by third drum electromagnet 415 attracts second portion of shredded ferrous materials 302, and wherein second portion of shredded ferrous materials 302 attach to third drum electromagnet 415 as third drum electromagnet 415 rotates about its longitudinal axis, and wherein second portion of shredded ferrous materials 302 remain attached to third drum electromagnet 415 until third drum electromagnet 415 reaches non-magnetized points 416, 417 and wherein non-magnetized points 416, 417 are areas where the magnetic field generated by third drum electromagnet 415 is not strong enough to attract second portion of shredded ferrous materials 302, thereby causing second portion of shredded ferrous materials 302 to detach from third drum electromagnet 415 and release onto fifth pair of sloped chutes 420, and wherein fifth pair of sloped chutes 420 directs second portion of shredded ferrous materials 302 drop into second ferrous collection section 425.

Still referring to FIG. 5, remaining shredded ferrous materials 300 left on fifth conveyor belt 400 after bypassing third drum electromagnet 415 form third portion of shredded ferrous materials 303 carried along with sixth portion of shredded non-ferrous materials 695. Third portion of shredded ferrous materials 303 carried along with sixth portion of shredded non-ferrous materials 695 are conveyed from second edge 510 of fifth conveyor belt 400 to first edge 520 of sixth conveyor belt 430. Workers W on both sides of first edge 520 of sixth conveyor belt 430 manually remove third portion of shredded ferrous materials 303 and place third portion of shredded ferrous materials 303 down sixth pair of sloped chutes 440, wherein sixth pair of sloped chutes 440 direct third portion of shredded ferrous materials 303 into third shredded ferrous collection section 445. Subsequently, workers W on both sides of second edge 530 of sixth conveyor belt 430 manually remove third portion of shredded ferrous materials 303 and place third portion of shredded ferrous materials 303 down seventh pair of sloped chutes 450, wherein seventh pair of sloped chutes 450 direct third portion of shredded ferrous materials 303 into fourth shredded ferrous collection section 455. Lastly, reaming sixth portion of shredded non-ferrous materials 695 drop from second edge 530 of sixth conveyor belt 430 to first end 540 of seventh conveyor belt 460 via second drop table 710, wherein sixth portion of shredded non-ferrous materials 695 are further conveyed towards second end 550 of seventh conveyor belt 460 and into final collection section 470. Accordingly, second separating section 360 removes shredded ferrous materials 300 from fourth portion of shredded non-ferrous materials 350 into first shredded ferrous collection section 412, second shredded ferrous collection section 425, third shredded ferrous collection section 445 and fourth shredded ferrous collection section 455.

It will be recognized by those skilled in the art that more than two or less than two chutes may be utilized in separating shredded ferrous and non-ferrous materials.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A metal recycling separator comprising:
a shredder, wherein said shredder comprises a shredding portion and a sloped shaking table, and wherein said sloped shaking table is disposed within said shredder and proximately below said shredding portion, and wherein said sloped shaking table comprises a first end and a second end, and wherein said sloped shaking table is disposed at a downward angle from said first end to said second end, and wherein said first end of sloped shaking table receives shredded materials from said shredding portion.

2. The metal recycling separator of claim 1, wherein said shredded materials comprise non-ferrous materials and ferrous materials, and wherein shaking of said sloped shaking table and travel of said non-ferrous materials and said ferrous materials toward said second end of said sloped shaking table causes said ferrous and said non-ferrous materials to disperse.

3. The metal recycling separator of claim 2, wherein said second end of said sloped shaking table is disposed proximate a first conveyor belt.

4. The metal recycling separator of claim 3, wherein said first conveyor belt conveys said non-ferrous materials and said ferrous materials to a first sloped chute and a first drum electromagnet.

5. The metal recycling separator of claim 4, wherein a first portion of said non-ferrous materials slides down said first sloped chute to a first non-ferrous collection section, and wherein concurrently said ferrous materials are magnetically attracted by said first drum electromagnet, and wherein a second portion of said non-ferrous materials are carried along with said ferrous materials as said ferrous materials are attracted to said first drum electromagnet.

6. The metal recycling separator of claim 5, wherein said first drum electromagnet circularly rotates, and wherein said first drum electromagnet is alternatively first energized to attract and retain said ferrous materials and is subsequently de-energized to deposit said ferrous materials onto a first end of a flat shaking table, and wherein said second portion of said non-ferrous materials are deposited onto said first end of said flat shaking table, and wherein said flat shaking further comprises a second end, and wherein said second end is disposed proximate a second sloped chute and a second drum electromagnet.

7. The metal recycling separator of claim 6, wherein shaking of said flat shaking table disperses said second portion of said non-ferrous materials and said ferrous materials to said second sloped chute and said second drum electromagnet.

8. The metal recycling separator of claim 7, wherein said second portion of said non-ferrous materials slides down said second sloped chute to a second non-ferrous collection section, and wherein concurrently said ferrous materials are magnetically attracted to said second drum electromagnet, and wherein a third portion of said non-ferrous materials are carried along with said ferrous materials as said ferrous materials is attracted to said second drum electromagnet.

9. The metal recycling separator of claim 8, wherein said second drum electromagnet circularly rotates, and wherein said second drum electromagnet is alternately first energized to attract and retain said ferrous materials and is subsequently de-energized to deposit said ferrous materials onto a first end of a second conveyor belt, and wherein said third portion of said non-ferrous materials are deposited onto said first end of said second conveyor belt, and wherein said second conveyor belt further comprises a second end.

10. The metal recycling separator of claim 9, wherein said third portion of said non-ferrous materials are manually removed from said second end of said second conveyer belt, and wherein said third portion of said non-ferrous materials slides down a third sloped chute to a third non-ferrous collection section, and wherein a fourth portion of said non-ferrous materials are left on said second conveyor belt with said ferrous materials, and wherein said second end of said second conveyor belt is disposed proximate a third conveyor belt comprising a first end and a second end.

11. The metal recycling separator of claim 10, wherein said fourth portion of said non-ferrous materials and said ferrous materials on said second end of said second conveyor belt are further conveyed to said first end of said third conveyor belt, and wherein said third conveyor belt carries said fourth portion of said non-ferrous materials and said ferrous materials to said second end of said third conveyor belt, and wherein said fourth portion of said non-ferrous materials and said ferrous materials drop off third conveyor belt to a first collection depository.

12. The metal recycling separator of claim 11, wherein said fourth portion of said non-ferrous materials and said ferrous materials in said first collection depository are transported to a bin, and wherein said bin comprises bin shakers, and wherein said bin is disposed proximate a first drop table, and wherein said first drop table is disposed proximate a water receptacle comprising a top, a bottom and a side, and wherein said first drop table comprises a first end and a second end, and wherein said first drop table is disposed at a downward angle from said first end toward said second end, and wherein said first end of said first drop table receives said fourth portion of said non-ferrous materials and said ferrous materials from said bin.

13. The metal recycling separator of claim 12, wherein shaking of said bin causes said fourth portion of said non-ferrous materials and said ferrous materials to disperse toward said second end of said first drop table and into said top of said water receptacle, and wherein a sloped sieve wall is disposed on said side of said water receptacle, and wherein a fourth conveyor belt is disposed proximate said bottom of said water receptacle, and wherein said water receptacle is selectively filled with water, and wherein a fraction of said water and a fifth portion of said non-ferrous materials float together out of said water receptacle and down said sloped sieve wall to a fourth non-ferrous collection section, and wherein said fraction of said water is drained through said sloped sieve wall, and wherein said ferrous materials and a sixth portion of said non-ferrous materials sink to said bottom of said water receptacle.

14. The metal recycling separator of claim 13, wherein said sixth portion of said non-ferrous materials and said ferrous materials in said bottom of said water receptacle are conveyed out of said water receptacle via said fourth conveyor belt, and wherein said fourth conveyor belt comprises a first end and a second end, and wherein said second end of said fourth conveyor belt is disposed proximate a fifth conveyor belt, and wherein said sixth portion of said non-ferrous materials and said ferrous materials are further conveyed to from said first end of said fourth conveyor belt to said second end of said fourth conveyor belt and onto a first end of said fifth conveyor belt via a first drop table.

15. The metal recycling apparatus of claim 14, wherein said first end of said fifth conveyor belt comprises a pair of fourth sloped chutes, and wherein a first portion of said ferrous materials are manually removed from said fifth conveyor belt and dropped down said pair of fourth sloped chutes to a first ferrous materials collection section, and wherein said fifth conveyor belt further comprises a second end, and wherein said second end of said fifth conveyor belt comprises a third drum electromagnet and a pair of fifth sloped chutes.

16. The metal recycling separator of claim 15, wherein a second portion of said ferrous materials and said sixth portion of said non-ferrous materials are conveyed together to said second end of said fifth conveyor belt, and wherein said third drum electromagnet circularly rotates, and wherein said third drum electromagnet alternately attracts said second portion of said ferrous materials and releases said second portion of said ferrous materials down said pair of fifth sloped chutes to a second ferrous materials collection, and wherein said second end of said fifth conveyor belt is disposed proximate a sixth conveyor belt, and wherein said sixth conveyor belt comprises a first end and a second end.

17. The metal recycling separator of claim 16, wherein a third portion of said ferrous materials and a sixth portion of said non-ferrous materials is conveyed onto said first end of said sixth conveyor belt, and wherein said sixth conveyor belt comprises a pair of sixth sloped chutes and a pair of seventh sloped chutes, and wherein a third portion of said ferrous materials are manually removed from said sixth conveyor belt and dropped down said pair of sixth sloped chutes to a third ferrous materials collection section, and wherein a fourth portion of ferrous materials remaining on said sixth conveyor belt are manually collected from said sixth conveyor belt and dropped down said pair of seventh sloped chutes to a fourth ferrous materials collection section, and wherein said sixth portion of said non-ferrous material is further conveyed to said second end of said sixth conveyor belt and drops onto a first end of a seventh conveyor belt via a second drop table, and wherein said seventh conveyor belt conveys said sixth portion of said non-ferrous materials to a final garbage section.

18. The metal recycling separator of claim 17, wherein said shredder, said first conveyor belt, said first drum electromagnet, said flat shaking table, said second electromagnet, said second conveyor belt, said third conveyor belt, said bin, said water receptacle, said fourth conveyor belt, said third drum electromagnet, said fifth conveyor belt and said sixth conveyor belt may selectively be grouped together into modular sections that can be deconstructed and reconstructed for transportation purposes.

19. A method of separating recyclable materials, wherein said method comprises the steps of:
obtaining a shredder, wherein said shredder comprises a shredding component and a sloped shaking table disposed internally within said shredder, and wherein said shredded is connects to a first conveyor belt, a first drum electromagnet, a flat shaking table, a second drum electromagnet, a second conveyor belt and a third conveyor belt;
placing materials into said shredder, wherein said materials are shredded into non-ferrous and ferrous materials, and wherein shaking of said sloped shaking table disperses said ferrous and non-ferrous materials;
conveying said non-ferrous and said ferrous materials to a first sloped chute and said first drum electromagnet via said first conveyor belt, wherein a first portion of said non-ferrous materials falls down said first sloped chute into a first non-ferrous collection section, and wherein concurrently said ferrous materials are magnetically attracted to said first drum electromagnet and subsequently released onto said flat shaking table, and wherein a second portion of said non-ferrous materials are carried along with said ferrous materials and conveyed onto said flat shaking table;
transferring said second portion of said non-ferrous materials and said ferrous materials to a second sloped chute and said second drum electromagnet, wherein said second portion of said non-ferrous materials fall down said second sloped chute into a second non-ferrous collection section, and wherein said ferrous materials are magnetically attracted to said second drum electromagnet and subsequently released onto said second conveyor belt, and wherein a third portion of said non-ferrous materials are carried along with said ferrous materials attracted to said second drum electromagnet and released onto said second conveyor belt;
removing said third portion of said non-ferrous materials from said second conveyor belt and down a third sloped chute, wherein said third sloped chute deposits said third portion of said non-ferrous materials into a third non-ferrous collection section; and
conveying a fourth portion of said non-ferrous materials and said ferrous materials onto said third conveyor belt, wherein said third conveyor belt conveys said fourth portion of said non-ferrous materials and said ferrous material into a collection section.

20. The method of claim 19, said method further comprising the steps of:
moving said ferrous materials and fourth portion of said non-ferrous materials from said collection section to a bin comprising bin shakers, wherein said bin is disposed proximate a sloped panel, and wherein said sloped panel is disposed proximate a water receptacle, and wherein said water receptacle comprises a sloped sieve wall disposed on the side thereof;
transferring said ferrous materials and said fourth portion of said non-ferrous materials from said bin into said water receptacle via said sloped panel and said bin shakers;
selectively filling said water receptacle with water, wherein a fifth portion of said non-ferrous materials floats out of said water receptacle onto said sloped sieve wall;
removing a sixth portion of said non-ferrous materials and said ferrous materials from said water receptacle via a fourth conveyor belt;
conveying said sixth portion of said non-ferrous materials and said ferrous materials on said fourth conveyor to a fifth conveyor belt, wherein said fifth conveyor belt comprises a fourth pair of sloped chutes, a third drum electromagnet and a fifth pair of sloped chutes;
removing a first portion of ferrous materials from said fifth conveyor belt;
depositing said first portion of ferrous materials from said fifth conveyor belt down said fourth pair of sloped chutes to a first ferrous collection section;
conveying remaining said ferrous materials and said sixth portion of ferrous materials under said third drum electromagnet, wherein a second portion of said ferrous materials are magnetically attracted to said third drum electromagnet and subsequently released down said fifth pair of sloped chutes to a second ferrous collection section;
conveying remaining said ferrous materials to a sixth conveyor belt, wherein said sixth conveyor belt comprises a sixth pair of sloped chutes and a seventh pair of sloped chutes;
removing a third portion of said ferrous materials from said sixth conveyor belt and depositing said third portion of said ferrous materials down said sixth pair of sloped chutes; and
removing a fourth portion of said ferrous materials from said sixth conveyor belt and depositing said fourth portion of said ferrous materials down said seventh pair of sloped chutes.

21. A shredder comprising a shredding component and a shaking table, wherein said shaking table is disposed underneath said shredding component, and wherein said shredding component drops shredded materials onto said shaking table, and wherein said shaking table disperses said shredded materials.
